(19) United States
(12) Patent Application Publication
(10) Pub. No.: US 2009/0222554 A1
(43) Pub. Date: Sep. 3, 2009

(54) Statistics for online advertising

(76) Inventor: James Paul Schneider, Raleigh, NC (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/074,048

(22) Filed: Feb. 28, 2008

(51) Int. Cl. G06F 17/00; G06F 15/173

(52) U.S. Cl. 709/224; 715/234

(57) ABSTRACT

An apparatus and a method for collecting online advertisement statistics is described. In one embodiment, a web browser of a client requests from a server, a web page having an advertisement banner. The web browser receives the web page and a JavaScript program. The browser loads the webpage and the JavaScript program which polls the browser of one or more property of an HTML image object included in the advertisement banner of the web page. The JavaScript program reports out the one or more property of the HTML image object.

### TECHNICAL FIELD

Embodiments of the present invention relate to computing systems, and more particularly, to estimating online display advertisements.

### BACKGROUND

A website is stored on a central computer known as the web server. Users around the world equipped with a web browser can enter the name of the website (URL) and download the pages comprising the site. By clicking HyperLinks within each page on the site the user navigates from page to page. As the user clicks on the links, the web server records information into a file known as a log file. The information written to the log file can include the IP Address of the client (user), the date and time, the type of request, the type of response from server URL requested, cookie information from the user, the type of browser used on the client.

Tracking banner advertisements viewed on a client can be difficult. Software programs exist that take the log file produced from the server and generate statistical information. However, this information can be innacurate as it tends to inflate some hits, and dramatically understates others. Thus, a need exists for a technique to accurately track the number of distinct impressions seen for a particular online display advertisement.

### BRIEF DESCRIPTION OF THE DRAWINGS

The present invention is illustrated by way of example, and not by way of limitation, in the figures of the accompanying drawings and in which:

FIG. 1 is a block diagram illustrating one embodiment of a system for counting online display advertisements.

FIG. 2 is a ladder diagram illustrating one embodiment of a system for counting online display advertisements.

FIG. 3 is a block diagram illustrating one embodiment of a client.

FIG. 4 is a flow diagram illustrating one embodiment of a method for counting online display advertisements.

FIG. 5 is a block diagram illustrating an example of a computer system.

### DETAILED DESCRIPTION

Described herein is a method and apparatus for collecting online advertisement statistics is described. In one embodiment, a browser of a client requests from a server, a web page having an advertisement banner. The browser receives the web page and a JavaScript program. The browser loads the webpage and the JavaScript program which polls the browser of one or more property of an HTML image object included in the advertisement banner of the web page. The JavaScript program reports out the one or more property of the HTML image object so as to enable to estimate the number of distinct impressions seen for a particular online display advertisement.

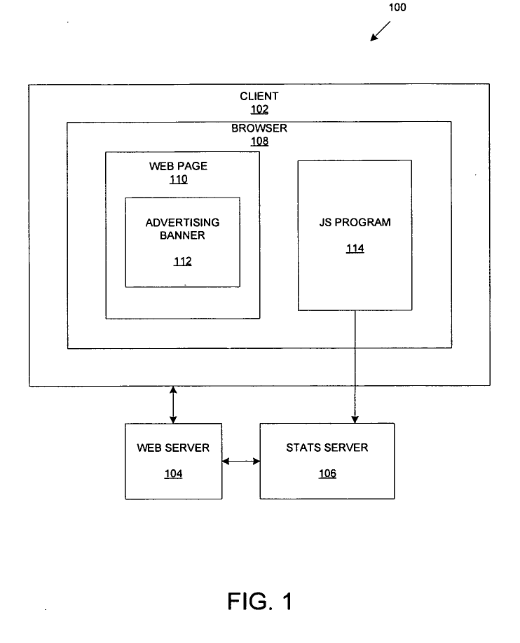

FIG. 1 is a block diagram illustrating one embodiment of a system 100 for counting online display advertisements. The system includes a client 102, a web server 104, and a statistics collection server 106. In another embodiment, the web server 104 and the statistics collection server 106 may reside on the same server.

Client 102 includes a web browser 108 configured to request from web server 104 a web page that may include an advertisement banner 112. Web browser 108 receives and loads web page 110 with advertisement banner 112. In one embodiment, web page 110 includes a JavaScript program 114 configured to poll web browser 108 of one or more property of an HTML image object included in advertisement banner 112 of web page 110. In one embodiment, JavaScript program 114 explicitly asks for permission from a user of client 102 and/or web browser 108 to access data on client 102. The user explicitly grants that permission to allow JavaScript program 114 to report out the one or more property of the HTML image object of advertisement banner 112 to statistics collection server 106. When one of the property of the HMTL is true, it means that the web browser has completely downloaded the associated image of advertisement banner 112. In one embodiment, the JavaScript program uses an XMLHttpRequest object to report out the one or more property of the HTML image object.

In another embodiment, both from a code reusability and a state management point, the JavaScript code can be stored in an external file, and can be referenced by a state-unique name. For example, instead of referencing it as “/js/reporterjs”, it can be referenced with “/js/reporterjs?{state id}”. This state can be propagated through the user's clickstream by associating that state id with each URL.

In another embodiment, a separate JavaScript Image object is created to pass results to statistics collection server 106.

Statistics collection server 106 receives the one or more property of the HTML image object and to compute statistics based on the one or more property of the HTML image object. In another embodiment, to handle the case where JavaScript is not available/turned off, status is reported when the web page is first loaded and when the image object itself is loaded. Then, server log entries can be matched up for page loads without corresponding status reports. Server 106 would then be able to estimate how many ads were loaded without corresponding status reports.

In one embodiment, web server 106 hosts web page 110 with banner advertisement 112. In another embodiment, another server coupled to web server 104 hosts only banner advertisement 112. In another embodiment, another server coupled to web server 104 schedules banner advertisement 112. In another embodiment, another server coupled to web server 104 hosts the JavaScript function library being used to report the statistics.

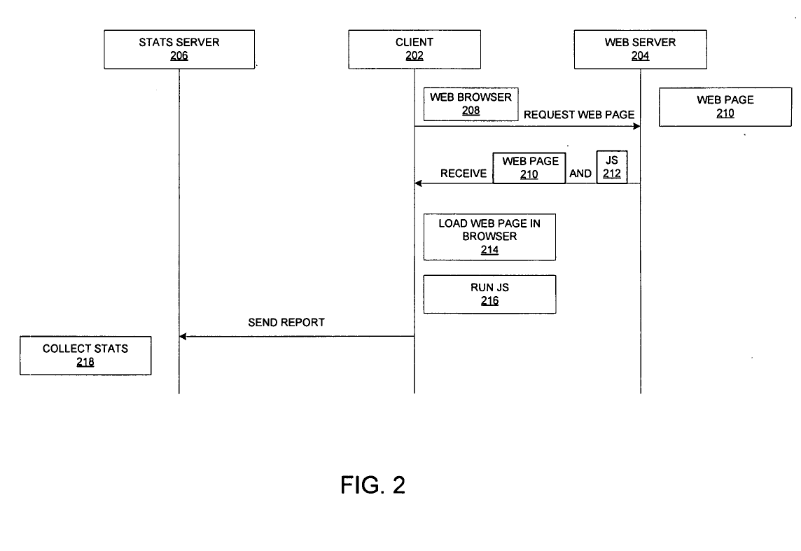

FIG. 2 is a ladder diagram illustrating one embodiment of a system for counting online display advertisements. A client 202 communicates with both a web server 204, and a statistics collection server 206. A web browser 208 of client 202 requests a web page 210 from web server 204. Client 202 receives web page 210 with a JavaScript program 212. In one embodiment, JavaScript program 212 is embedded in web page 210.

Web browser 208 loads web page 210 and runs JavaScript program 212 with user client's explicit permission. Client 202 then sends out a report to collection statistics server 218.

In one embodiment, JavaScript program 212 is configured to periodically poll web browser 208 of one or more property of an HTML image object associated with an advertisement banner of web page 210. JavaScript program 212 reports out the one or more property of the HTML image object of advertisement banner 112 to statistics collection server 106. When one of the property of the HMTL is true, it means that the web browser has completely downloaded the associated image of advertisement banner 112. In one embodiment, the JavaScript program uses an XMLHttpRequest object to report out the one or more property of the HTML image object. In another embodiment, the report could contain anything available to a JavaScript program: cookie values, document's lastModified date, browser name, etc. In another embodiment, a separate JavaScript Image object is created to pass results to statistics collection server 106.

In one embodiment, web server 204 hosts web page 210 with banner advertisement. In another embodiment, another server coupled to web server 204 only hosts banner advertisement. In another embodiment, another server coupled to web server 204 schedules the various banner advertisements to be included in web page 210. In another embodiment, another server coupled to web server 204 hosts the JavaScript function library being used to report the statistics.

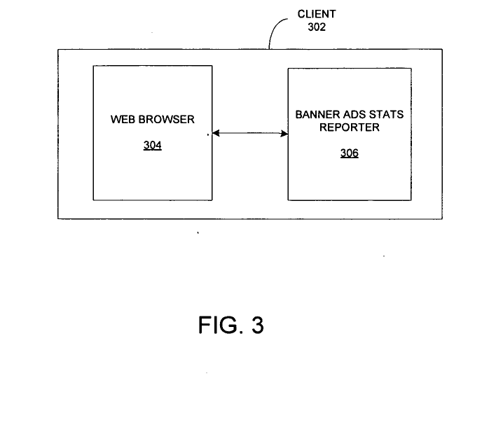

FIG. 3 is a block diagram illustrating one embodiment of a client 302. Client 302 includes a web browser 304 and a advertisement banner reporter 306. Web browser 304 requests from a server, a web page that includes an advertisement banner. Web browser 304 receive and load the web page and runs a JavaScript program to generate advertisement banner reporter 306 with client 302 user's permission. Advertisement banner reporter 306 periodically polls web browser 306 of one or more property of an HTML image object associated with the advertisement banner of the downloaded web page. Advertisement banner reporter 306 then reports out the one or more property of the HTML image object.

In one embodiment, the JavaScript program uses an XMLHttpRequest object to report out the one or more property of the HTML image object. In another embodiment, the JavaScript program is stored in an external file to the web page, the external file referenced with a state identifier. In another embodiment, advertisement banner reporter 306 sends the one or more property of the HTML image object to an other server that is configured to compute statistics based on the one or more property of the HTML image object. In another embodiment, a separate JavaScript Image object is created to pass results to statistics collection server 106.

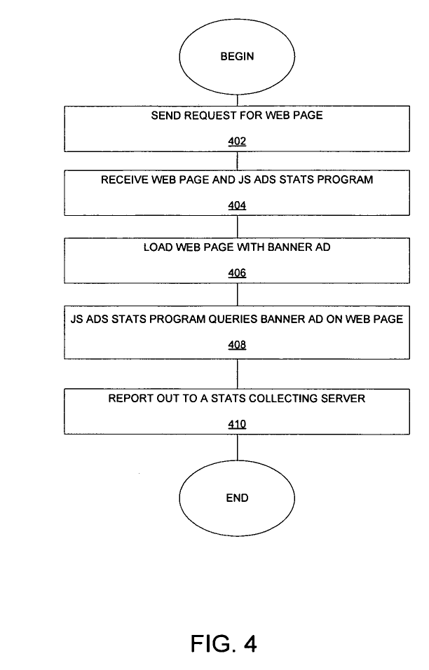

FIG. 4 is a flow diagram illustrating one embodiment of a method for counting online display advertisements. At 402, a web browser of a client sends out a request for a web page from a web server. At 404, the web browser receives the requested web page along with a JavaScript program. In one embodiment, the JavaScript program is embedded in the downloaded web page. At 406, the web browser loads the requested web page that includes a banner advertisement. At 408, the web browser executes the associated JavaScript program, with client user's permission, to periodically polls the web browser for one or more property of an HTML image object associated with the banner advertisement. When one of the property of the HMTL is true, it means that the web browser has completely downloaded the associated image of advertisement banner 112. At 410, client then sends out a report to a statistics collection server.

In one embodiment, the JavaScript program uses an XMLHttpRequest object to report out the one or more property of the HTML image object. In another embodiment, the report could contain anything available to a JavaScript program; cookie values, document's lastModified date, browser name, etc. In another embodiment, a separate JavaScript Image object is created to pass results to statistics collection server.

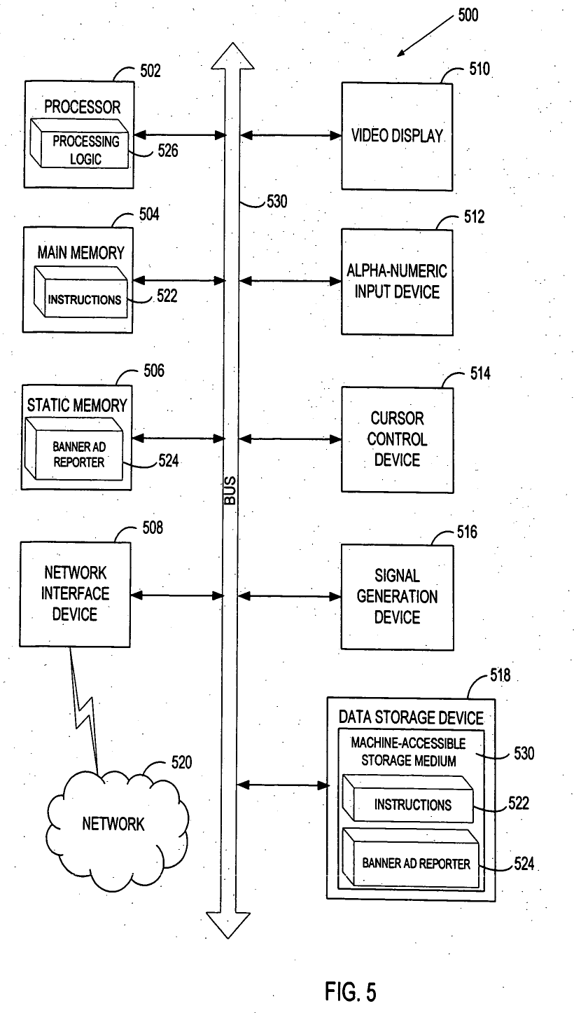

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device 502, a main memory 504 (e.g., read-only memory (ROM), flash memory, dynamic random access memory (DRAM) such as synchronous DRAM (SDRAM), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute the processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-accessible storage medium 530 on which is stored one or more sets of instructions (e.g., software 522) embodying any one or more of the methodologies or functions described herein. The software 522 may also reside, completely or at least partially, within the main memory 504 and/or within the processing device 502 during execution thereof by the computer system 500, the main memory 504 and the processing device 502 also constituting machine-accessible storage media. The software 522 may further be transmitted or received over a network 520 via the network interface device 508.

The machine-accessible storage medium 530 may also be used to store the banner ad reporter 524 as presently described. The banner ad reporter 524 may also be stored in other sections of computer system 500, such as static memory 506.

While the machine-accessible storage medium 530 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical and magnetic media, and carrier wave signals.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
a web browser of a client requesting from a server, a web page comprising an advertisement banner;
receiving the web page and a JavaScript program, the JavaScript program configured to poll the web browser of one or more property of an HTML image object included in the advertisement banner of the web page; and
loading the web page and the JavaScript program, the JavaScript program configured to report out the one or more property of the HTML image object.

2. The computer-implemented method of claim 1 wherein the JavaScript program uses an XMLHttpRequest object to report out the one or more property of the HTML image object.

3. The computer-implemented method of claim 1 wherein the JavaScript program uses an XMLHttpRequest object to report out one or more property of a separately created JavaScript Image object.

4. The computer-implemented method of claim 1 wherein the JavaScript program is stored in an external file to the web page, the external file referenced with a state identifier.

5. The computer-implemented method of claim 2 further comprising:
sending the one or more property of the HTML image object to an other server, the other server configured to compute statistics based on the one or more property of the HTML image object.

6. The computer-implemented method of claim 5 wherein the server is configured to report out the server log entries for the web page being loaded to the client to the other server.

7. An article of manufacture comprising:
a computer-accessible storage medium including data that, when accessed by a computer, cause the computer to perform a method comprising:
a web browser of a client requesting from a server a web page comprising an advertisement banner;
receiving the web page and a JavaScript program, the JavaScript program configured to poll the web browser of one or more property of an HTML image object included in the advertisement banner of the web page; and
loading the web page and the JavaScript program, the JavaScript program configured to report out the one or more property of the HTML image object.

8. The article of manufacture of claim 7 wherein the JavaScript program uses an XMLHttpRequest object to report out the one or more property of the HTML image object.

9. The article of manufacture of claim 7 wherein the JavaScript program uses an XMLHttpRequest object to report out one or more property of a separately created JavaScript Image object.

10. The article of manufacture of claim 7 wherein the JavaScript program is stored in an external file to the web page, the external file referenced with a state identifier.

11. The article of manufacture of claim 8 wherein the method further comprises:
sending the one or more property of the HTML image object to an other server, the other server configured to compute statistics based on the one or more property of the HTML image object.

12. The article of manufacture of claim 11 wherein the server is configured to report out the server log entries for the web page being loaded to the client to the other server.

13. A client comprising:
a web browser configured to request from a server a web page comprising an advertisement banner, to receive and load the web page and a JavaScript program; and
an advertisement banner reporter coupled to the web browser, the advertisement banner reporter configured to execute the JavaScript program, the JavaScript program configured to poll the browser of one or more property of an HTML image object included in the advertisement banner of the web page, and to report out the one or more property of the HTML image object.

14. The client of claim 13 wherein the JavaScript program uses an XMLHttpRequest object to report out the one or more property of the HTML image object.

15. The client of claim 13 wherein the JavaScript program uses an XMLHttpRequest object to report out one or more property of a separately created JavaScript Image object.

16. The client of claim 13 wherein the JavaScript program is stored in an external file to the web page, the external file referenced with a state identifier.

17. The client of claim 14 wherein the advertisement banner report is configured to send the one or more property of the HTML image object to an other server, the other server configured to compute statistics based on the one or more property of the HTML image object.

18. The client of claim 17 wherein the server is configured to report out the server log entries for the web page being loaded to the client to the other server.

19. A system comprising:
a client comprising a web browser configured to request from a server a web page comprising an advertisement banner, to receive and load the web page and a JavaScript program; and
a server coupled to the client, the server configured to generate the web page and the JavaScript program, the JavaScript program configured to poll the web browser of one or more property of an HTML image object included in the advertisement banner of the web page, and to report out the one or more property of the HTML image object.

20. The system of claim 19 wherein the JavaScript program uses an XMLHttpRequest object to report out the one or more property of the HTML image object.

21. The system of claim 19 wherein the JavaScript program uses an XMLHttpRequest object to report out one or more property of a separately created JavaScript Image object.

22. The system of claim 19 wherein the JavaScript program is stored in an external file to the web page, the external file referenced with a state identifier.

23. The system of claim 20 further comprising:
a statistics collection server coupled to the client, the statistics collection server configured to receive the one or more property of the HTML image object and to compute statistics based on the one or more property of the HTML image object.

24. The system of claim 23 wherein the server is configured to report out the server log entries for the web page being loaded to the client to the statistics collection server.
